(19) United States
(12) Patent Application Publication
(10) Pub. No.: US 2026/0136137 A1
(43) Pub. Date: May 14, 2026

(54) SOUND PRODUCTION CONTROL METHOD, HEAD-MOUNTED DISPLAY DEVICE, AND COMPUTER STORAGE MEDIUM

(71) Applicant: GOERTEK TECHNOLOGY CO., LTD, Qingdao, Shandong (CN)

(72) Inventor: Jian ZHANG, Qingdao, Shandong (CN)

(21) Appl. No.: 19/118,403

(22) PCT Filed: Nov. 17, 2023
(86) PCT No.: PCT/CN2023/132315

§ 371 Date: Apr. 4, 2025

(30) Foreign Application Priority Data
Nov. 21, 2022 (CN) 202211458130.0

(51) Int. Cl. H04R 3/04; H04R 3/14; H04R 29/00

(52) U.S. Cl. CPC H04R 3/04; H04R 3/14; H04R 29/002; H04R 2420/07

(57) ABSTRACT

The present disclosure provides a sound production control method, a head-mounted display device, and a computer storage medium, the sound production control method includes: receiving speaker frequency sweep signals of a plurality of speakers, and determining a bass sound production speaker according to each of the speaker frequency sweep signals; determining correction curves corresponding to the speaker frequency sweep signals respectively based on a pre-stored target frequency response, and gathering the correction curves corresponding to the speaker frequency sweep signals to obtain a correction curve set; and determining speaker position information corresponding to the speaker frequency sweep signals according to a collected instruction transceiving delay value, and performing a sound production control according to the speaker position information, the correction curve set and the bass sound production speaker. The present disclosure improves sound production effect of the head-mounted display device at low frequencies.

This application claims priority to Chinese patent application No. 202211458130.0, entitled “SOUND PRODUCTION CONTROL METHOD, HEAD-MOUNTED DISPLAY DEVICE, AND COMPUTER STORAGE MEDIUM” filed with the Chinese Patent Office on Nov. 21, 2022, which is incorporated herein by reference in its entirety.

### TECHNICAL FIELD

The present disclosure relates to the field of sound processing technologies, and in particular, to a sound production control method, a head-mounted display device, and a computer storage medium.

### BACKGROUND

Currently, head-mounted display devices such as VR (Virtual Reality) devices or AR (Augmented Reality) devices on the market are gradually increased, and due to the immersive feeling of the head-mounted display devices, they are widely used in games and immersive movies, but due to the tendency of the head-mounted display devices to be lightweight, the head-mounted display devices do not have many choices on sound production units, and therefore the head-mounted display devices do not perform well at low frequencies. For example, due to the limitation of the lightweight of the head-mounted display device and the limitation of its own sound production mode, the head-mounted display device can only produce sound through its own speaker unit, which cannot realize the diversity of sound production units and cause poor sound production effect at low frequencies.

Therefore, during the process of applying the above method, there is a defect that sound production can only be performed through the speaker unit of the head-mounted display device, thereby causing a poor sound production effect of the head-mounted display device at low frequencies.

### SUMMARY

A main object of the present disclosure is to provide a sound production control method, a head-mounted display device and a computer storage medium, aiming to solve the technical problem of poor sound production effect of the head-mounted display device at low frequencies.

To achieve the above objects, the present disclosure provides a sound production control method applied to a head-mounted display device, and the sound production control method includes the following steps:
receiving speaker frequency sweep signals of a plurality of speakers, and determining a bass sound production speaker according to each of the speaker frequency sweep signals;
determining correction curves corresponding to the speaker frequency sweep signals respectively based on a pre-stored target frequency response, and gathering the correction curves corresponding to the speaker frequency sweep signals to obtain a correction curve set; and
determining speaker position information corresponding to the speaker frequency sweep signals according to a collected instruction transceiving delay value, and performing a sound production control according to the speaker position information, the correction curve set, and the bass sound production speaker.

Optionally, the step of determining the bass sound production speaker according to each of the speaker frequency sweep signals includes:
sequentially determining bass sound performance curves corresponding to the speaker frequency sweep signals respectively, and detecting whether each of the bass sound performance curves matches a pre-stored optimal bass sound performance curve, wherein Fourier transform is performed on the speaker frequency sweep signals to obtain performance curves, and the bass sound performance curves are curves with frequency values less than a preset frequency value among the performance curves; and
if a bass sound performance curve matches the pre-stored optimal bass sound performance curve, determining a speaker corresponding to a speaker frequency sweep signal matching the optimal bass sound performance curve as the bass sound production speaker.

Optionally, the step of determining correction curves corresponding to the speaker frequency sweep signals respectively based on a pre-stored target frequency response includes:
determining mid-high sound performance curves corresponding to the speaker frequency sweep signals respectively, and determining speaker frequency responses corresponding to the mid-high sound performance curves, wherein the mid-high sound performance curves are curves with frequency values greater than or equal to the preset frequency value among the performance curves;
determining differences between the speaker frequency responses and the pre-stored target frequency response as correction dashed lines; and
receiving speaker sound production signals corresponding to the correction dashed lines, and performing the sound production control according to the speaker sound production signals and the correction dashed lines to obtain correction curves.

Optionally, the step of performing the sound production control according to the speaker sound production signals and the correction dashed lines to obtain the correction curves includes:
determining the mid-high sound performance curves in the speaker sound production signals, and performing frequency response calibrations on the mid-high sound performance curves based on the correction dashed lines to obtain sound production frequency responses; and
detecting whether differences between the sound production frequency responses and the target frequency response are less than a preset value; and

If the differences between the sound production frequency responses and the target frequency response is less than the preset value, determining that the correction dashed lines are the correction curves.

Optionally, the method includes: before the step of determining the speaker position information corresponding to the speaker frequency sweep signals according to the collected instruction transceiving delay value,
determining high frequency sound pressure information corresponding to the speaker frequency sweep signals, and determining a maximum sound pressure direction in the high frequency sound pressure information as a speaker angle position;
obtaining a first delay value which is a time delay value between a time at which an instruction is played and a time at which the instruction is received at an initial position;
obtaining a second delay value which is a time delay value between a time at which an instruction is played and a time at which the instruction is received at an end position; and
taking a difference between the first delay value and the second delay value as an instruction transceiving delay value; and
the step of determining the speaker position information corresponding to the speaker frequency sweep signals according to the collected instruction transceiving delay value includes:
determining a speaker distance corresponding to the collected instruction transceiving delay value, and taking the speaker distance corresponding to the speaker angle position as the speaker position information corresponding to the sound frequency sweep signals.

Optionally, the step of performing the sound production control according to the speaker position information, the correction curve set and the bass sound production speaker includes:
determining a sound production demand corresponding to an audio to be played, and detecting whether the sound production demand is a mid-high sound production demand;
if the sound production demand is a mid-high sound production demand, receiving a mid-high sound frequency response sent from the speakers, determining a target correction curve of the mid-high frequency response in the correction curve set, and performing a frequency response calibration on the mid-high sound frequency response based on the speaker position information and the target correction curve, to perform mid-high sound production; and
if the sound production demand is not the mid-high sound production demand, controlling the bass sound production speaker to produce bass sound.

Optionally, the method includes: before the step of receiving the speaker frequency sweep signals of the plurality of speakers,
establishing Bluetooth connections with Bluetooth of the speakers; and
sequentially sending speaker frequency sweep signal demand instructions to the plurality of speakers based on the Bluetooth connections, and
the step of receiving the speaker frequency sweep signals of the plurality of speakers includes:
receiving the speaker frequency sweep signals generated by the plurality of speakers based on the speaker frequency sweep signal demand instructions.

Optionally, the method further includes: after the step of receiving the speaker frequency sweep signals of the plurality of speakers,
determining a personalized sound production speaker according to each of the speaker frequency sweep signals;
determining a personalized correction curve corresponding to the personalized sound production speaker based on a pre-stored personalized target frequency response; and
determining personalized speaker position information corresponding to the personalized sound production speaker according to a collected personalized instruction transceiving delay value, and performing the sound production control according to the personalized speaker position information and the personalized correction curve.

The present disclosure also provides a head-mounted display device, which is a physical device, and the head-mounted display device includes: a memory, a processor, and a program for achieving a sound production control method stored in the memory and executable by the processor, wherein when the program for achieving the sound production control method is executed by the processor, the steps of the foregoing sound production control method may be implemented.

The present disclosure also provides a computer storage medium on which a program for achieving a sound production control method is stored, wherein the program for achieving the sound production control method is executed by a processor to implement the steps of the foregoing sound production control method.

The present disclosure also provides a computer program product, including a computer program, wherein when the computer program is executed by a processor, the steps of the foregoing sound production control method are implemented.

The technical solution of the present disclosure includes: receiving speaker frequency sweep signals of a plurality of speakers, and determining a bass sound production speaker according to each of the speaker frequency sweep signals; determining a correction curve corresponding to the speaker frequency sweep signal based on a pre-stored target frequency response, and gathering the correction curves corresponding to each of the speaker frequency sweep signals to obtain a correction curve set; determining speaker position information corresponding to the speaker frequency sweep signal according to the collected instruction transceiving delay value, and performing sound production control according to the speaker position information, the correction curve set, and the bass sound production speaker, so that the head-mounted display device performs mid-high sound production according to the speaker position information and the correction curve set and performs bass sound production according to the bass sound production speaker, thereby achieving the effect of improving the sound production effect of the head-mounted display device at low frequencies.

In the prior art, a stereo system is established by using Bluetooth and a sound box, but a stereo system may be established by using a head-mounted display device such as a VR type product and a sound box; on one hand, compared to a traditional stereo sound box where the acoustic performance of the sound box does not change with the movement of the human body, the VR type product can well capture the movement of the human body and the position of the human body due to the existence of an inertial measurement unit (IMU) and a camera, so that real-time calibration can obtain a more realistic sound environment. On the other hand, since the sound producing units of the sound box are more diversified, there are high frequency units, medium frequency units and low frequency units.

In addition, since the user, on the one hand, determines the bass sound production speaker through the speaker frequency sweep signal, controls the head-mounted display device to implement the bass sound according to the bass sound production speaker, and on the other hand, determines the correction curve corresponding to the speaker frequency sweep signal based on the pre-stored target frequency response, and then determines the correction curve set of the speaker, and also determines the speaker position information corresponding to the speaker frequency sweep signal, and finally controls the head-mounted display device to realize the mid-high sound production according to the speaker position information and the correction curve set, that is, the head-mounted display device can realize the bass sound through the bass sound production speaker, and can also correct the mid-high sound production of the speaker by using the correction curve set in the head-mounted display device, and realize personalized sound production based on the mid-high sound production of the speaker and the correction curve, thereby overcoming the limitations of lightweight of the head-mounted display device and sound production mode of the head-mounted display device, and the problems that the head-mounted display device can only produce sound through the speaker unit of the head-mounted display device, and thus cannot realize the diversity of the sound production units of the head-mounted display device and causes the poor sound production effect of the head-mounted display device at low frequencies, so that the present disclosure can eliminate the bass sound production defects of the current head-mounted display device to the greatest extent, and then produce sound through the speaker together with the internal speaker unit of the head-mounted display device, thereby realizing the personalized selection of the sound production, and improving the sound production effect of the head-mounted display device at low frequencies through the sound production of the bass sound.

### BRIEF DESCRIPTION OF DRAWINGS

The accompanying drawings, which are incorporated in and constitute a part of this specification, illustrate embodiments consistent with the present disclosure and, together with the description, serve to explain the principles of the present disclosure.

To illustrate the technical solutions in the embodiments of the present disclosure or in the prior art more clearly, the following brief description to the accompanying drawings required to be used for describing the embodiments or the prior art will be given, and apparently, for a person having ordinary skill in the art, other accompanying drawings may also be obtained based on these accompanying drawings without creative efforts.

FIG. 1 is a schematic flowchart of a sound production control method according to Embodiment 1 of the present disclosure;

FIG. 2 is a schematic flowchart of a sound production control method according to Embodiment 2 of the present disclosure;

FIG. 3 is a schematic diagram of a scenario constituted by a head-mounted display device and a speaker according to an embodiment of the present disclosure;

FIG. 4 is a schematic flowchart of performing sound production calibration on a head-mounted display device according to an embodiment of the present disclosure;

FIG. 5 is a schematic flowchart of performing personalized sound production calibration on a head-mounted display device according to an embodiment of the present disclosure; and

FIG. 6 is a schematic diagram of a device structure of a hardware operating environment related to a head-mounted display device according to an embodiment of the present disclosure.

The objectives, functional features, and advantages of the present disclosure will be further described with reference to the accompanying drawings.

### DETAILED DESCRIPTIONS

To achieve the foregoing objectives, features, and advantages of the present disclosure clearer, the following clearly and completely describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person having ordinary skill in the art based on the embodiments of the present disclosure without creative efforts shall fall within the protection scope of the present disclosure.

In this embodiment, the head-mounted display device of the present disclosure may be, for example, Mixed Reality-MR device (e.g., MR glasses or MR helmet), Augmented Reality-AR device (e.g., AR glasses or AR helmet), Virtual Reality-VR device (e.g., VR glasses or VR helmet), Extended Reality-XR device, or a combination thereof.

At present, head-mounted display devices such as VR products, do not have many choices on the speakers due to the development tendency of the head-mounted display devices to be lightweight. Due to the influence of the limited installation space, the speakers do not have many choices in size, which will cause poor performance of the VR product at low frequencies due to the size of the speaker. For example, when a user plays a game by using the VR product, a sound production effect of the VR product during bass sound production is poor, thereby affecting game experience of the user.

### Embodiment 1

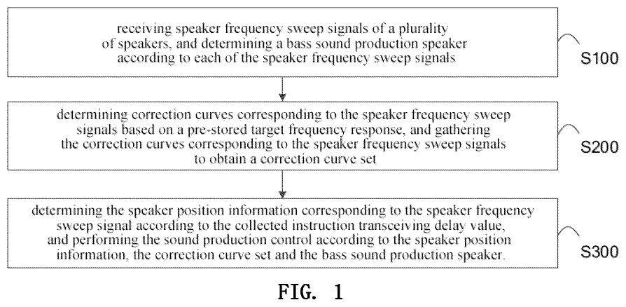

Based on this, referring to FIG. 1 which is a schematic flowchart of a sound production control method according to Embodiment 1, the present embodiment provides a sound production control method, the sound production control method include:

Step S100, receiving speaker frequency sweep signals of a plurality of speakers, and determining a bass sound production speaker according to each of the speaker frequency sweep signals;
In this embodiment, a system is established by connecting a VR device and a plurality of speakers via Bluetooth, and then the VR device of the system is calibrated to implement sound production control. In the process of calibration, regarding receiving speaker frequency sweep signals of a plurality of speakers, the plurality of speakers refer to the speakers in the system, the number of the speaker frequency sweep signals is corresponding to the number of the speakers in the system, and the speaker frequency sweep signal is a signal that is emitted from the speaker and that continuously changes from low frequency to high frequency, or from high frequency to low frequency. Based on influence of the speaker of the VR device having small size, the bass sound production speaker is determined according to the speaker frequency sweep signals, and the bass sound production speaker refers to a speaker dedicated to bass sound production in the VR device in the present embodiment. Further, when the VR device needs to perform bass sound production, the bass sound production speaker is controlled via Bluetooth to produce sound, thereby avoiding a poor sound production effect of the existing VR device in the low frequency band.

Step S200, determining correction curves corresponding to the speaker frequency sweep signals respectively based on a pre-stored target frequency response, and gathering the correction curves corresponding to the speaker frequency sweep signals to obtain a correction curve set;

In this embodiment, after the bass sound production speaker is determined, sounding calibration is performed on the mid-high sound. After the correction curve corresponding to the speaker frequency sweep signal is sequentially determined according to the pre-stored target frequency response, and the correction curves corresponding to all of the speaker frequency sweep signals are combined to obtain the correction curve set, the obtained correction curve set is written into an equalizer of the VR device to be called when processing the mid-high sound. The target frequency response refers to a frequency response obtained when an internal speaker of the VR device sounds, the correction curve refers to a curve that corrects the frequency response of the mid-high sound of the speaker, and the correction curve set refers to correction curves of the mid-high sound of the speaker corresponding to all of the speaker frequency sweep signals, and because the mid-high sound is generated by the speaker and a speaker unit inside the VR device together, the mid-high sound of the speaker needs to be corrected using the correction curve and then sounds together with the speaker unit inside the VR device. On the other hand, in the mid-high sound, a phase difference may be even larger than an intensity difference, and thus the directivity of high sound is strong, so it is necessary to determine the position and angle of the mid-high sound, so as to adjust the mid-high sound of the speaker, to improve the reality simulation performance of the VR device.

Step S300, determining speaker position information corresponding to the speaker frequency sweep signals according to a collected instruction transceiving delay value, and performing a sound production control according to the speaker position information, the correction curve set and the bass sound production speaker.

In this embodiment, because the phase difference of the above-mentioned mid-high sound may be even larger than the intensity difference, the directivity of the mid-high sound is strong, so it is necessary to determine the speaker position information corresponding to the speaker frequency sweep signal according to the collected instruction transceiving delay value, that is, the position information of the speaker corresponding to the speaker frequency sweep signal is determined according to the instruction transceiving delay value. The instruction transceiving delay value refers to a difference in the instruction transceiving delay between a starting position and a position that is infinitely close to the endpoint, and then a distance of the speaker from the starting position may be calculated according to the characteristics of the sound, and an angle between the speaker and the starting position may also be determined by the high frequency sound, that is, the orientation information of the speaker at the starting position. Finally, the mid-high sound production control of the VR device is performed according to the speaker position information and the correction curve set, so that the joint sounding of the speaker and the VR device is realized, and the diversity of the sounding units of the VR device is improved; the bass sound production control of the VR device is performed through the bass sound production speaker, thereby avoiding the problem of poor bass sound production effect of the VR device in the prior art.

The technical solution of the present disclosure includes: receiving speaker frequency sweep signals of a plurality of speakers, and determining a bass sound production speaker according to each of the speaker frequency sweep signals; determining a correction curve corresponding to the speaker frequency sweep signal based on a pre-stored target frequency response, and gathering the correction curves corresponding to each of the speaker frequency sweep signals to obtain a correction curve set; determining speaker position information corresponding to the speaker frequency sweep signal according to a collected instruction transceiving delay value, and performing sound production control according to the speaker position information, the correction curve set, and the bass sound production speaker, so that the head-mounted display device performs mid-high sound production according to the speaker position information and the correction curve set and performs bass sound production according to the bass sound production speaker, thereby achieving the purpose of improving the sound production effect of the head-mounted display device at low frequencies.

In the prior art, a stereo system is established by using Bluetooth and a sound box, but a stereo system may be established by using a head-mounted display device such as a VR type product and a sound box; on one hand, compared to a traditional stereo sound box where the acoustic performance of the sound box does not change with the movement of the human body, the VR products can well capture the movement of the human body and the position of the human body due to the existence of an inertial measurement unit (IMU) and a camera, so that a more realistic sound environment can be obtained by real-time calibration. On the other hand, since the sound producing units of the sound box are more diversified, there are high frequency units, medium frequency units and low frequency units.

In addition, since the user, on the one hand, determines the bass sound production speaker through the speaker frequency sweep signal, controls the head-mounted display device to implement the bass sound according to the bass sound production speaker, and on the other hand, determines the correction curves corresponding to the speaker frequency sweep signals based on the pre-stored target frequency response, and then determines the correction curve set of the speakers, and also determines the speaker position information corresponding to the speaker frequency sweep signal, and finally controls the head-mounted display device to realize the mid-high sound production according to the speaker position information and the correction curve set. That is, the head-mounted display device can perform the bass sound through the bass sound production speaker, and can also correct the mid-high sound production of the speaker by using the correction curve set in the head-mounted display device to perform mid-high sound production, and realize personalized sound production based on the mid-high sound production of the speaker and the correction curve, thereby overcoming the limitations of lightweight of the head-mounted display device and the sound production mode of the head-mounted display device, and the problems that the head-mounted display device can only produce sound through the speaker unit of the head-mounted display device, and thus cannot realize the diversity of the sound production units of the head-mounted display device and causes the poor sound production effect of the head-mounted display device at low frequencies, so that the present disclosure can maximumly eliminate the bass sound production defects of the head-mounted display device in prior art, and produce sound through the speaker together with the internal speaker unit of the head-mounted display device, thereby realizing a personalized selection of the sound production, and improving the sound production effect of the head-mounted display device at low frequencies through the bass sound production speaker.

In an embodiment, the step of determining the bass sound production speaker according to each of the speaker frequency sweep signals includes:

Step A10, sequentially determining bass sound performance curves corresponding to each of the speaker frequency sweep signals respectively, and detecting whether each of the bass sound performance curves matches a pre-stored optimal bass sound performance curve, wherein Fourier transform is performed on the speaker frequency sweep signals to obtain performance curves, and the bass sound performance curves are curves with frequency values less than a preset frequency value among the performance curves;

Step A20, if a bass sound performance curve matches the pre-stored optimal bass sound performance curve, determining a speaker corresponding to a speaker frequency sweep signal matching the optimal bass sound performance curve as the bass sound production speaker.

In this embodiment, because the VR device has a poor bass sound production effect, the VR device is connected to the speaker via Bluetooth, so as to control the speaker to generate the bass sound to avoid the poor bass sound production effect of the VR device.

After receiving the speaker frequency sweep signals, the bass sound performance curves are obtained by sequentially performing Fourier transform on the speaker frequency sweep signals (by obtaining the performance curve, the curve with frequency values less than the preset frequency value in the performance curve is the bass sound performance curve), whether the bass sound performance curve matches the pre-stored optimal bass sound performance curve is detected, and if the bass sound performance curve matches the pre-stored optimal bass sound performance curve, the speaker corresponding to the speaker frequency sweep signal matching the optimal bass sound performance curve is determined as the bass sound production speaker. That is, the speaker corresponding to the speaker frequency sweep signal matching the optimal bass sound performance curve among the plurality of speaker frequency sweep signals is determined, and the speaker is used as the bass sound production speaker, and then the speaker is controlled to perform the bass sound in subsequent control. The bass sound performance curve refers to a sound production curve of the speaker in bass sound production, the optimal bass sound performance curve refers to a bass curve with desirable bass effect, and the matching refers to that the bass sound performance curve meets the requirement of the optimal bass sound performance curve. For example, the optimal bass sound performance curve is curve A, and the bass sound performance curve is curve B; if the bass effect of curve B can be better than curve A, it is determined that the bass sound performance curve matches the optimal bass sound performance curve, and the bass effect can be indicated by the roundness and stability of the curve.

After the step of detecting whether the bass sound performance curve matches the pre-stored optimal bass sound performance curve, the method includes:

Step A30, determining a pre-stored device bass sound performance curve, and detecting whether each of the bass sound performance curves matches the device bass sound performance curve;

Step A40, if a bass sound performance curve matches the device bass sound performance curve, determining a speaker corresponding to a speaker frequency sweep signal matching the device bass sound performance curve as the bass sound production speaker.

When there is no speaker frequency sweep signal matching the optimal bass sound performance curve, a pre-stored device bass sound performance curve is determined, and whether the bass sound performance curve matches the device bass sound performance curve is detected. If the bass sound performance curve does not match the device bass sound performance curve, determination of the bass sound production speaker is ended, and the bass sound production is performed by continue using the VR device; if the bass sound performance curve matches the device bass sound performance curve, the speaker corresponding to the speaker frequency sweep signal matching the device bass sound performance curve is determined as the bass sound production speaker. The device bass sound performance curve refers to the bass sound performance curve of the VR device itself, and bass sound production is performed by determining the bass sound production speaker which matches the device bass sound performance curve, so that the bass sound production effect of the VR device can be effectively improved.

Further, in a possible embodiment, the step of determining a correction curve corresponding to the speaker frequency sweep signal based on a pre-stored target frequency response includes:

Step B10, determining mid-high sound performance curves in the speaker frequency sweep signals respectively, and determining speaker frequency responses corresponding to the mid-high sound performance curves, wherein the mid-high sound performance curves are curves with frequency values higher than or equal to a preset frequency value among the performance curves;

Step B20, determining differences between the speaker frequency responses and a pre-stored target frequency response as correction dashed lines;

Step B30, receiving speaker sound production signals corresponding to the correction dashed lines, and performing the sound production control according to the speaker sound production signals and the correction dashed lines to obtain correction curves.

In this embodiment, after the bass sound of the VR device is calibrated, the mid-high sound in the VR device is calibrated. Because the sound production demand of the mid-high sound (the mid-high sound performance curve is a curve with frequency values higher than or equal to the preset frequency value (which may be 300 Hz) in the performance curve), that is, the mid-high sound production of the VR device is performed by the speaker unit of the VR device and the mid-high sound of the speaker, in order to prevent the discordance between the sound of the two, it is necessary to correct the mid-high sound of the speaker to realize mid-high sound production together with the speaker unit of the VR device. By performing Fourier transform on the speaker frequency sweep signal to obtain the mid-high sound performance curve thereof, and determining speaker frequency response corresponding to the mid-high sound performance curve, the difference between the speaker frequency response and the pre-stored target frequency response is used as the correction dashed line, that is, the difference between the frequency response of the mid-high sound performance curve and the target frequency response of the mid-high sound of the sound of the speaker unit inside the VR device is determined. Here, the mid-high sound performance curve refers to a sound curve corresponding to the mid-high sound in the speaker frequency sweep signal, the speaker frequency response refers to a frequency response for the mid-high sound corresponding to the mid-high sound performance curve, the target frequency response refers to a frequency response of the mid-high sound of the speaker unit inside the VR device, and the correction dashed line refers to a correction curve for calibration, and it is determined that the correction dashed line is the correction curve only after the correction dashed line is calibrated to meet the requirement. After the correction dashed line is determined, the correction dashed line is calibrated to obtain the correction curve.

After the step of determining differences between the speaker frequency responses and a pre-stored target frequency response as the correction dashed lines, the method further includes:

Step B21, determining a target speaker corresponding to a correction dashed line, and generating a sound production demand instruction based on the correction dashed line;

Step B22, sending the sound production demand instruction to the target speaker.

In this embodiment, a manner of calibrating the correction dashed line is to determine the target speaker corresponding to the correction dashed line, and determine to obtain the speaker frequency sweep signal of the correction dashed line so as to determine the target speaker corresponding to the correction dashed line. Because the correction dashed line needs to be calibrated, after the correction dashed line is obtained, a sound production demand instruction is generated, and the target speaker is controlled to produce sound by the sound production demand instruction, and a speaker sound production signal that causes the target speaker to produce sound based on the sound production demand instruction of the correction dashed line and send sound is received. Here, the target speaker refers to a speaker corresponding to the correction dashed line, the sound production demand instruction refers to an instruction for controlling the target speaker to produce sound via Bluetooth, and the speaker sound production signal refers to a sound signal transmitted to the VR device by the speaker that generates sound based on the sound production demand instruction. Further, this step may also be generating a mid-high sound production demand instruction based on the correction dashed line, so as to implement the target speaker to send the mid-high sound signal, and the mid-high sound production demand instruction refers to an instruction for controlling the speaker to send the mid-high sound. Because only the mid-high sound is calibrated by the actual correction curve, a mid-high sound requirement may be directly sent to the speaker, and after the speaker sound production signal or the mid-high sound signal is received, the sound production control is performed based on the speaker sound production signal or the mid-high sound signal and the correction dashed line, to obtain a correction curve, that is, further verify whether the previously obtained correction dashed line meets the requirements, and by verifying through actual sound production, the accuracy of the correction curve can be ensured.

In another possible embodiment, the step of performing sound production control according to the speaker sound production signal and the correction dashed line to obtain a correction curve includes:

Step C10, determining the mid-high sound performance curves in the speaker sound production signals, and performing frequency response calibrations on the mid-high sound performance curves based on the correction dashed lines to obtain sound production frequency responses;

Step C20, detecting whether differences between the sound production frequency responses and the target frequency response are less than a preset value; and

Step C30, if the differences are less than the preset value, determining that the correction dashed lines are the correction curves.

In this embodiment, when calibrating the correction dashed line, by determining the mid-high sound performance curve in the speaker sound production signal or the mid-high sound signal, the mid-high sound performance curve is determined in the same manner as the above mentioned mid-high sound performance curve determining manner, and both are obtained through Fourier transformation. After that, the mid-high sound performance curve is calibrated according to the correction dashed line to obtain sound production frequency response. The sound production frequency response refers to the mid-high sound production frequency response obtained by calibrating the speaker sound production signal or the mid-high sound signal, and by comparing a difference between the sound production frequency response and the target frequency response with a preset value, when the difference is less than the preset value, it is determined that the correction dashed line meets the requirement, and then the correction dashed line is determined as the correction curve, the difference between the sound production frequency response and the target frequency response refers to a difference between the two in the whole frequency response, and the preset value refers to the optimal frequency response difference defined by the user. Otherwise, when the difference is not less than the preset value, the step of receiving the speaker sound production signal corresponding to the correction dashed line is performed based on taking the difference between the sound production frequency response and the pre-stored target frequency response as a correction dashed line. By calibrating the correction dashed line, the accuracy of the determined correction curve can be ensured, thereby ensuring the accuracy of the controlling on the mid-high sound Speaker 1 in the VR device.

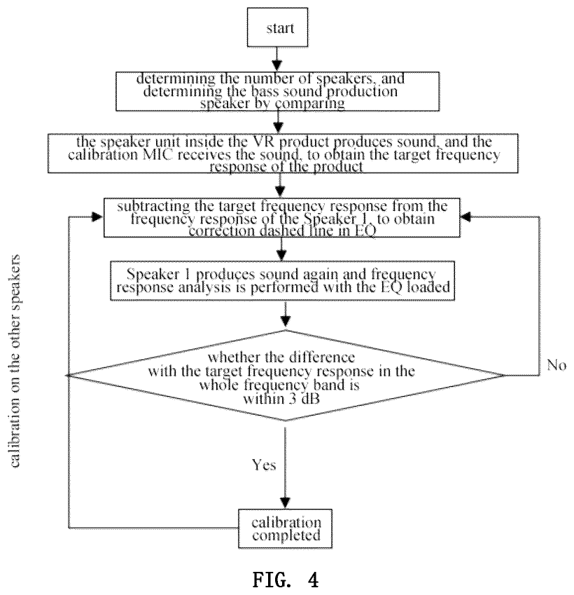

Further, referring to FIG. 4, FIG. 4 is a schematic flowchart of performing sound production calibration on the head-mounted display device. By determining the number of speakers, and comparing the speaker frequency sweep signals of the speakers to determine the speaker which is better in bass sound production as the bass sound production speaker, a speaker module inside the VR product produces sound, and a calibration MIC (microphone) receives the sound, so that a target frequency response of the VR product can be determined. Each speaker is sequentially calibrated. Taking the Speaker 1 as an example, by subtracting the target frequency response from the frequency response of the mid-high sound of the speaker frequency sweep signal of the Speaker 1, the correction dashed line of the Speaker 1 may be obtained, and the correction dashed line is stored in an equalizer EQ. Further, the Speaker 1 is controlled to produce sound again, and frequency response analysis is performed on this sound production with the correction dashed line in the equalizer EQ, and it is detected whether the difference between the sound production frequency response and the target frequency response in the whole frequency band is within 3 dB, if the difference between the sound production frequency response and the target frequency response in the whole frequency band is within 3 dB, the calibration on Speaker 1 is completed. Otherwise, a difference between the frequency response of this sound production of the Speaker 1 and the target frequency response is detected again, so as to obtain the correction dashed line of the Speaker 1, until the difference between the sound production frequency response and the target frequency response in the whole frequency band is within 3 dB, the correction curve calibration on the Speaker 1 is completed, and the correction curve calibration on other speakers is then performed, so that the correction curve of all of the speakers in the mid-high sound can be determined, and then when the VR device is used, the speakers can be corrected to produce the mid-high sound, thereby achieving the accuracy and authenticity of the mid-high sound production.

In an embodiment, before the step of determining the speaker position information corresponding to the speaker frequency sweep signals according to the collected instruction transceiving delay value, the method includes:

Step D10, determining high frequency sound pressure information corresponding to the speaker frequency sweep signals, and determining a maximum sound pressure direction in the high frequency sound pressure information as a speaker angle position;

Step D20, obtaining a first delay value, wherein the first delay value is a time delay value between a time at which an instruction is played and a time at which the instruction is received at an initial position;

Step D30, obtaining a second delay value, wherein the second delay value is a time delay value between a time at which an instruction is played and a time at which the instruction is received at an end position;

Step D40: taking a difference between the first delay value and the second delay value as an instruction transceiving delay value.

In this embodiment, because a phase difference of the sound waves of the left and right ears may be even larger than an intensity difference, the directivity of high sound is strong. Therefore, it is necessary to calibrate the end position, thereby ensuring the directivity of the mid-high sound, and improving the mid-high sound experience of the user when using the VR device. Regarding determining high frequency sound pressure information corresponding to the speaker frequency sweep signal, the high frequency sound pressure information refers to sound pressures at different positions for the sound having high frequency, and when the speaker produces high frequency sound, it is determined that the maximum sound pressure direction in the high frequency sound pressure information is the speaker angle position, which is a direction of the speaker with respect to a wearer. A distance between the position of the wearer and the speaker may be determined based on the speaker angle position, and by determining the first delay value between a first play instruction at the initial position and a first receiving instruction, while determining the second delay value between a second play instruction at the end position and a second receiving instruction, the difference between the first delay value and the second delay value is finally used as the instruction transceiving delay value. The initial position refers to a position at which the wearer wears the VR device, and is generally a fixed position to start to use the VR device, and the end position refers to a position at which the wearer wears the device and gets infinitely close to the speaker, the first play instruction and the first receiving instruction refer to an instruction for controlling the speaker to play sound sent by the wearer at the initial position and an instruction that the sound played by the speaker is received, the second play instruction and the second receiving instruction refer to an instruction for controlling the speaker to play sound sent by the wearer at the end position and an instruction that the sound played by the speaker is received, the first delay value refers to a time delay value between the first play instruction and the first receiving instruction, the second delay value refers to a time delay value between the second play instruction and the second receiving instruction, and then the difference between the two delay values is determined as the instruction transceiving delay value, and by determining the delay values of the end position and the initial position, it can be ensured that the delay time of sending the internal instructions does not affect the distance determination, and the accuracy of the distance determination is further improved.

The step of determining the speaker position information corresponding to the speaker frequency sweep signal according to the collected instruction transceiving delay value includes:

Step D50, determining a speaker distance corresponding to the collected instruction transceiving delay value, and taking the speaker distance corresponding to the speaker angle position as the speaker position information corresponding to the speaker frequency sweep signals.

In this embodiment, regarding determining the speaker distance corresponding to the instruction transceiving delay value, the determining step is to accurately determine the speaker distance according to the instruction transceiving delay value and the sound speed, and the speaker distance refers to a distance from the initial position to the end position. By determining the speaker distance through the instruction transceiving delay value between the two positions, the problem that the distance is inaccurately determined due to the influence caused by actual instruction transceiving, internal instruction processing and internal delay. Finally, the speaker distance corresponding to the speaker angle position may be determined as the speaker position information corresponding to the speaker frequency sweep signal, that is, the angle of the speaker and the distance from the initial distance in the entire area may be determined, so that the speaker sounding and the distance may be associated, thereby improving the authenticity of sound production of the VR device. In another aspect, when the VR device is equipped with a camera, the speaker position information is directly determined by using the camera, so that the speaker position information is combined with the wearer's movement, thereby improving the authenticity of sound production of the VR device.

In a possible embodiment, the step of performing sound production control according to the speaker position information, the correction curve set, and the bass sound production speaker includes:

Step E10, determining a sound production demand corresponding to an audio to be played, and detecting whether the sound production demand is a mid-high sound production demand;

Step E20, if the sound production demand is a mid-high sound production demand, receiving a mid-high sound frequency response sent from the speakers, determining a target correction curve of the mid-high frequency response in the correction curve set, and performing a frequency response calibration on the mid-high sound frequency response based on the speaker position information and the target correction curve, to perform mid-high sound production;

Step E30, if the sound production demand is not the mid-high sound production demand, controlling the bass sound production speaker to produce bass sound.

In this embodiment, when performing the sound production control, a sound production demand is determined based on the audio to be played, that is, by using the speaker position information, how many decibels of sound the wearer needs the speaker to produce at that position and the carried sound production demand are determined, wherein the audio to be played is audio that is demanded to be played. The sound production demand refers to what kind of sound is required to control the speaker to emit, including bass sound and mid-high sound, and there is a requirement on the decibel only for mid-high sound. The method further includes: before determining the sound production demand based on the speaker position information,

Step E01, collecting angle information, and correcting the speaker position information based on the angle information;

Step E02, updating the speaker position information according to the corrected speaker position information.

In this embodiment, because the position of the user may be fixed at each wearing, but the actual angle may be deviated, the angle information may be determined by using the IMU, and then the speaker position information is corrected according to the angle information, the angle information refers to an angle between when wearing the VR device and when calibrating. That is, the speaker position information when calibrating may be directly in front, and in this case, the default angle information is 0 degrees. When the angle information is 30 degrees to the right when being worn, the speaker position information may be corrected to be 30 degrees to the left of the front, and then the speaker position information may be updated with the corrected speaker position information, thereby ensuring the accuracy of the speaker position information during each use, and further improving the accuracy of subsequent mid-high sound production control. There is also an extreme case where the user may start wearing on a circle centered on the speaker, and then the speaker position information may be updated by using the maximum sound pressure direction in the high frequency sound pressure information as the speaker angle position according to the collected angle information and the early calibration.

Regarding detecting whether the sound production demand is a mid-high sound production demand, the mid-high sound production demand refers to whether a mid-high sound production needs to be performed. When it is not needed to produce the mid-high sound, the bass sound production speaker is directly controlled via Bluetooth to produce bass sound, and for the bass sound production speaker, because the orientation of the bass sound is not strong, it does not need to determine the speaker position information of the speaker, but when the bass sound production speaker performs mid-high sound production, it is necessary to determine the speaker position information. Otherwise, when the mid-high sound is required to be produced, the speaker is controlled to perform mid-high sound production, and the mid-high sound frequency response sent from at least one speaker is received. Here, taking Speaker 2 as an example, the mid-high sound frequency response refers to a frequency response for mid-high sound. The target correction curve of the mid-high sound in the correction curve set is determined, that is, the target correction curve of the Speaker 2 in the correction curve set is determined, and the target correction curve refers to a correction curve obtained by the Speaker 2 in the previous calibration, and frequency response calibration is performed on the mid-high sound frequency response based on the target correction curve, to perform mid-high sound production. That is, the mid-high sound emitted from the speaker undergoes frequency response calibration (correcting the mid-high sound frequency response) by using the corresponding correction curve, and then together with the speaker unit inside the VR device, the mid-high sound is produced. On the one hand, the mid-high sound production is performed by combining the mid-high sound in the speaker with the internal speaker unit, which realizes the diversification of the sound production units, and on the other hand, the speaker bass sound production can be directly performed by the bass sound production speaker to improve the sound production effect of the bass sound of the VR device. After the step of performing frequency response calibration on the mid-high sound frequency response based on the target correction curve to perform mid-high sound production, the method includes:

Step E21, collecting movement information in real time, and determining a mid-high sound control instruction based on the movement information and the speaker position information;

Step E22, controlling at least one speaker to generate a specified mid-high sound frequency response based on the mid-high sound control instruction;

Step E23, performing a frequency response calibration on the specified mid-high sound frequency response based on the target correction curve, to perform a mid-high sound production.

In this embodiment, in actual use of a VR device, by correcting movement information in real time, a mid-high sound control instruction is determined based on the movement information and the speaker position information, the movement information refers to information such as the distance of movement of the wearer and the angle, and the mid-high sound control instruction refers to an instruction for controlling to produce the mid-high sound. That is, the sound producing standard corresponding to the mid-high sound is determined according to the distance and the angle as the user moves. For example, if the mid-high sound is D meters ahead, and the user moves straight by C meters (C<D), it is determined that the sound production demand of the mid-high sound of the speaker after the user's movement, and then the mid-high sound control instruction is generated to control the speaker to realize the mid-high sound production. Then, the step of controlling the at least one speaker to generate the specified mid-high sound frequency response based on the mid-high sound control instruction is performed, and the processing flow is consistent with the step of receiving the mid-high sound frequency response sent from the at least one speaker, except that the former generates the specified mid-high sound frequency response according to the control of the mid-high sound control instruction, and the latter generates the mid-high sound frequency response according to the mid-high sound production demand. That is, the specified mid-high sound frequency responses are different at different positions, and therefore, the control instruction needs to be controlled to generate different specified mid-high sound frequency responses at different positions. The specified mid-high sound frequency response refers to a mid-high sound frequency response that needs to be generated corresponding to the control instruction, and different specified mid-high sound frequency responses are generated at different positions to realize the authenticity of the mid-high sound production in the speaker.

In a possible embodiment, before the step of receiving the speaker frequency sweep signal of the plurality of speakers, the method includes:

Step F10, establishing Bluetooth connections with Bluetooth of multiple speakers;

Step F20, sequentially sending a speaker frequency sweep signal demand instruction to each speaker based on the Bluetooth connection.

In this embodiment, in the system established based on the head-mounted display device and the speaker via the Bluetooth connection, the Bluetooth connection is established by turning on the Bluetooth of the head-mounted display device and the Bluetooth of the speakers, thereby realizing the control of the whole system. The speaker frequency sweep signal demand instruction is sequentially sent to each speaker by using the Bluetooth connection to the head-mounted display device, and the speaker frequency sweep signal demand instruction refers to an instruction sent from the head-mounted display device to the speaker to generate and transmit the speaker frequency sweep signal. The speaker which receives the instruction will generate a speaker frequency sweep signal and transmits the speaker frequency sweep signal to the head-mounted display device, and the head-mounted display device performs calibration based on the received speaker frequency sweep signal, and on the one hand, determines the bass sound production speaker by using the speaker frequency sweep signal, thereby implementing bass sound production, and on the other hand, by determining the correction curve of the mid-high sound and the speaker position information through the speaker frequency sweep signal, the mid-high sound production can be implemented.

The step of receiving the speaker frequency sweep signal of the at least one speaker includes:

Step F30, receiving a speaker frequency sweep signal generated by the at least one speaker based on the speaker frequency sweep signal demand instruction.

In this embodiment, the speaker frequency sweep signal demand instruction is sent to the speaker, the speaker then sent back the speaker frequency sweep signal, and the head-mounted display device receives the speaker frequency sweep signal generated by the at least one speaker based on the speaker frequency sweep signal demand instruction. The at least one speaker refers to the speaker connected to the head-mounted display device via Bluetooth, that is, the speaker in a system constituted by the speakers and the head-mounted display device, the sound frequency sweep signal demand instruction is sequentially sent to each speaker in the system, so that a speaker frequency sweep signal sent from each speaker can be received. Calibration of bass and mid-high sound production of the head-mounted display device based on the speaker frequency sweep signal can be performed, thereby improving the bass sound production effect of the head-mounted display device.

### Embodiment 2

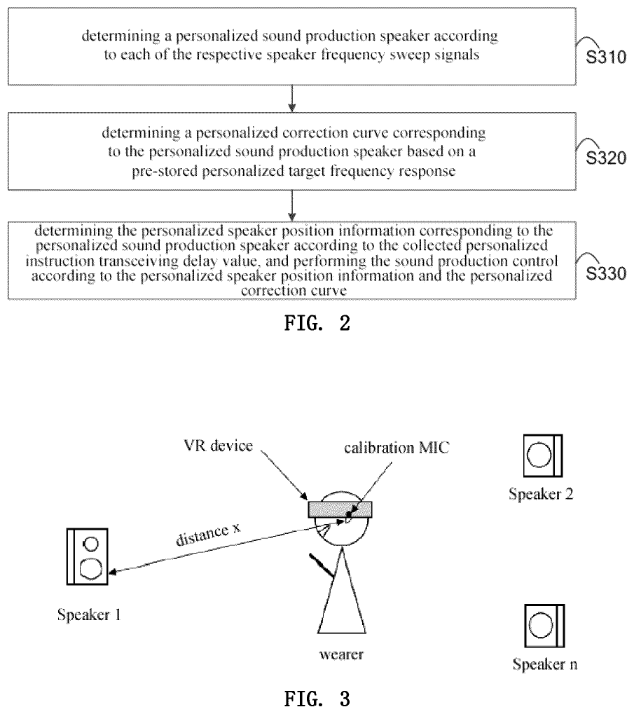

Based on Embodiment 1 of the present disclosure, in another embodiment of the present disclosure, same or similar content as the foregoing Embodiment 1 may refer to the foregoing description, and details thereof are not described in the following description. Based on this, referring to FIG. 2 which illustrates a schematic flowchart of Embodiment 2 of the sound production control method, and the method further includes: after the step of obtaining the sound frequency sweep signal of all of the speakers,

Step S310, determining a personalized sound production speaker according to each of the speaker frequency sweep signals;

In this embodiment, because the mid-high sound is produced by in combination with the speaker, a personalized sound production demand can be realized by the speaker. The speaker frequency sweep signal is used to determine the personalized sound production speaker, and the processing flow of which is consistent with the process of determining the bass sound production speaker according to each of the speaker frequency sweep signals. The step of determining the personalized sound production speaker according to each of the speaker frequency sweep signals includes:

Step G10, sequentially determining mid-high sound performance curves in the speaker frequency sweep signals, and detecting whether each of the mid-high sound performance curves matches a pre-stored optimal personalized sound performance curve, wherein the mid-high sound performance curves are obtained by performing Fourier transform on the speaker frequency sweep signals;

Step G20, if a mid-high sound performance curve matches the pre-stored optimal personalized sound performance curve, determining a speaker corresponding to the speaker frequency sweep signal matching the optimal personalized sound performance curve as the personalized sound production speaker, and mainly detecting whether the intensity difference and the phase difference of the mid-high sound performance curve after the Fourier transform meet the intensity difference and the phase difference requirements in the optimal personalized sound performance curve. The only difference lies in that the personalized sound production speaker detection is whether the mid-high performance curve matches the pre-stored optimal personalized sound performance curve, the optimal personalized sound performance curve refers to the mid-high sound curve that meets the mid-high sound effect, and specifically may be a certain frequency point of the actual mid-high sound, and then the personalized sound production speaker at the frequency point is determined. There may also be processes of step A30 and step A40, and then it is determined that the personalized sound production speaker may be determined according to the sound production at a certain frequency and the sound production effect of the device at the frequency point. The personalized sound production speaker refers to a speaker that emits personalized mid-high sound, which can personalize mid-high sound production according to user's requirements, thereby improving the functionality of the VR device and improving user experience and selectivity.

Step S320, determining a personalized correction curve corresponding to the personalized sound production speaker based on a pre-stored personalized target frequency response;

Step S330, determining the personalized speaker position information corresponding to the personalized sound production speaker according to the collected personalized instruction transceiving delay value, and performing the sound production control according to the personalized speaker position information and the personalized correction curve.

In this embodiment, after the personalized sound production speaker is determined, the personalized correction curve corresponding to the personalized sound production speaker is determined based on the pre-stored personalized target frequency response. The specific steps of which are the same as the step S200 of Embodiment 1, except that the personalized target frequency response is the subtrahend for obtaining the personalized correction curve, but in step S200, the target frequency response is the subtrahend for obtaining the correction curve. The personalized target frequency response refers to frequency response for personalizing the speaker unit inside the VR device, for example, the target frequency response is 20 dB, and the personalized target frequency response may be defined as 10 dB or 5 dB. And then, the personalized speaker position information corresponding to the personalized sound production speaker is determined according to the collected personalized instruction transceiving delay value, and the sound production control is performed according to the personalized speaker position information and the personalized correction curve, the personalized speaker position information refers to a position of the personalized sound production speaker, because the personalized sound belongs to the mid-high sound production, it is necessary to determine the position to realize the authenticity of the sound production control, and the personalized instruction transceiving delay value refers to a delay value of instruction transceiving for the personalized sound production speaker. In this way, personalized mid-high sound production is realized by changing the personalized correction curve by using the personalized target frequency response, thereby improving the sound production diversity of the VR device.

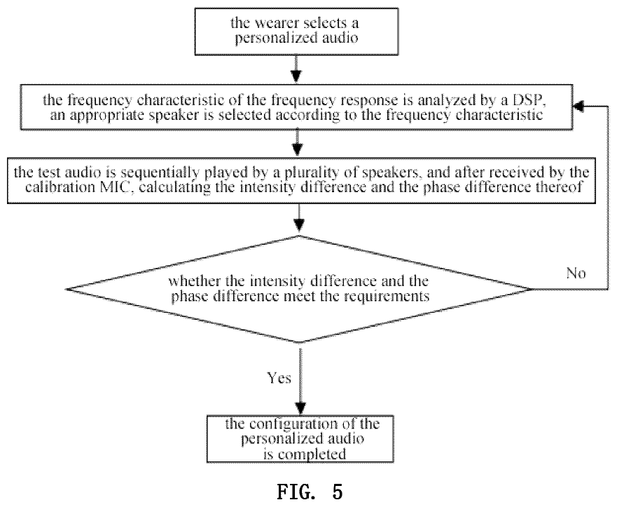

Further, referring to FIG. 5, FIG. 5 is a schematic flowchart of performing personalized sound production calibration on the head-mounted display device, when the wearer selects a personalized audio, the frequency characteristic of the frequency response is analyzed by a digital signal processor (DSP), an appropriate speaker is selected according to the frequency characteristic, and revalidation is performed on the selected speaker again. The test audio is sequentially played by a plurality of speakers, and after received by the calibration MIC, intensity difference and the phase difference are calculated by using the Fourier transform, and then whether the intensity difference and the phase difference thereof meet the requirements is determined. When the requirements are met, it is determined that the appropriate speaker is selected as the personalized sound production speaker, otherwise, performing the step of determining the appropriate speaker again according to the test audio until the intensity difference and the phase difference meet the requirements, and this step may be a step for calibration and control of the personalized speaker after the step of obtaining all the input speaker frequency sweep signals. The personalized sound production may be realized for the VR device through the determination of the personalized sound production speaker, which extends the selectivity of the sound production of the VR device.

In another possible embodiment, the step of performing sound production control according to the personalized speaker position information and the personalized correction curve includes:

Step K10, if a personalized demand instruction is received, determining a target personalized sound production speaker corresponding to the personalized demand instruction;

Step K20, performing a personalized sound production based on the target personalized sound production speaker.

In this embodiment, during use of the user, by inputting the personalized demand instruction, the VR device controls the target personalized sound production speaker to produce sound according to the target personalized sound production speaker corresponding to the personalized demand instruction, and modifies the target personalized correction curve corresponding to the target personalized sound production speaker, the personalized demand instruction refers to an instruction input by the user to select a personalized sound production, and the target personalized sound production speaker refers to a speaker corresponding to the personalized sound production for the user. For example, if the personalized demand instruction is heavy high sound, Speaker 3 corresponding to the heavy high sound determined during the previous calibration is determined as target personalized sound production speaker, and the sound is produced through the Speaker 3. The personalized sound production of the VR device is implemented through personalized sound production control, and the functionality of the VR device is extended.

To help understand the technical concept of the present disclosure, a specific embodiment is provided:

The head-mounted display device in this specific embodiment is a VR device, and the VR device generates a virtual world in a three-dimensional space through computer simulation. In the support of play plug-ins such as Java or Quicktime, ActiveX, Flash, etc., the user may also perform operations such as zooming in, zooming out, and rotating to the image, allowing the user to experience an unparalleled sense of realism, stereoscopic effect, and immersion that is beyond typical 2D images or 3D models, and in this embodiment, a stereo system is established by using the VR device, Bluetooth and the speakers, thereby supporting more diversified sounding units, including high frequency units, medium frequency units, and low frequency units. Its usage scenario is shown in FIG. 3, which is a schematic diagram of a scenario constructed by a head-mounted display device and speakers. The VR device establishes a Bluetooth connection to the speaker in the system (including the VR device and the plurality of speakers) via Bluetooth, and may further realize controlling the speaker to produce sound via Bluetooth of the VR device (the bass sound is produced by a specific bass sound production speaker, and the mid-high sound is corporately produced by the speaker unit of the VR device and the mid-high sound production speaker), so that information with poor bass sound effect when the VR device performs sounding may be overcome, and a requirement of personalized sound production may also be selected by the user through an extension of the sound production. When performing calibration, speaker frequency sweep signals are sent from all of the speakers in the Bluetooth control system, and then correction curves of the bass sound production speaker and each of the speakers are determined according to each of the speaker frequency sweep signals. In addition, by performing position determination on all of the speakers while correcting, for example, a distance between the Speaker 1 and the VR device is X in the drawings, the wearer may further determine whether the calibration MIC needs to perform sound production change according to whether the wearer walks. For example, the wearer wears the VR device to continuously approach the Speaker 1, and the mid-high sound of the calibration MIC changes to be larger (decibel value higher); otherwise, far away from the Speaker 1, the mid-high sound of the calibration MIC will change to be smaller (decibel value lower), and also the angles will have certain affects, for example, whether the mid-high sound production is at the rear or the front.

A position change and an angle change when the wearer wearing the VR device is determined by using an IMU in the VR device. The bass sound does not have such problem about the position and angle changes. Based on the principle of sound source positioning, it can be learned that when a sound emitted from a sound source arrives at two ears of a person, there is a sound pressure level, a time difference, a phase difference, and the like, which are processed by the human brain, to allow the person perceives an orientation of the sound source, i.e., sound image positioning. The sound source positioning capability of the human ear is also related to the frequencies, and is poor at low frequencies below 300 Hz (bass sound), because the diffraction ability of the bass sound is strong. Its wavelength is much larger compared to the distance between the two ears of the person, the phase difference and the intensity difference obtained by the human ear are very small, and then the positioning effect is also small, so the home theater in the home generally only needs one super bass speaker, and the placement position is arbitrary, and no angle and position requirements are required. The capability of sound localization is gradually enhanced above 300 Hz (mid-high sound). As the frequency increases, the wavelength becomes shorter, and when the sound reaches the human ear, the distance between the two ears of the human is not negligible compared with its wavelength. At this time, the phase difference of the sound wave received by the left and right ears may be even larger than the intensity difference, and thus the directivity of the high sound is strong. Therefore, it is necessary to determine a position and an angle relationship for the mid-high sound production of the speaker, so as to determine how to change the sound production decibel value of the mid-high sound when the wearer moves or after the movement according to the position and the angle relationship, so as to improve the authenticity of the VR device, and sound can be generated through the specific bass sound production speaker and then the bass sound production effect is improved through the VR device.

It should be noted that many details described in this specific embodiment are merely for understanding the technical concept of the present disclosure, and do not constitute a limitation on the present disclosure, and more forms of simple transformations based on the technical concept of the present disclosure shall fall within the protection scope of the present disclosure.

### Embodiment 3

An embodiment of the present disclosure provides a head-mounted display device, including: at least one processor; and a memory communicatively connected to the at least one processor, wherein the memory stores instructions executable by the at least one processor, and the instructions are executed by the at least one processor, so that the at least one processor can perform the sound production control method in Embodiment 1.

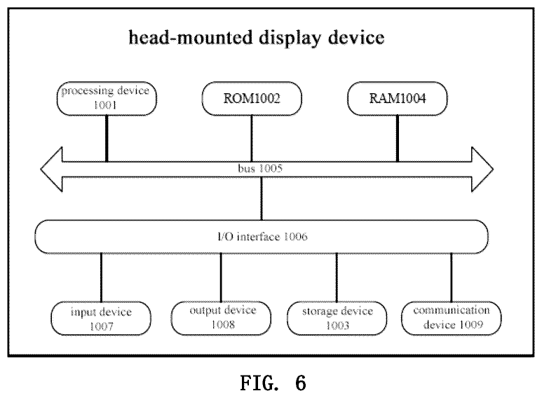

Referring to FIG. 6, FIG. 6 is a schematic diagram of a device structure of a hardware operating environment related to a head-mounted display device, which shows a schematic structural diagram of a head-mounted display device suitable for implementing the embodiments of the present disclosure. The head-mounted display device in the embodiments of the present disclosure may include, but is not limited to, a MR (Mixed Reality) device (e.g., MR glasses or MR helmet), AR (Augmented Reality) device (e.g., AR glasses or AR helmet), VR (Virtual Reality) device (e.g., VR glasses or VR helmet), XR (Extended Reality) device, or some combination thereof. The head-mounted display device shown in FIG. 6 is only an example, and should not bring any limitation to the function and scope of use of the embodiments of the present disclosure.

As shown in FIG. 6, the head-mounted display device may include a processing device 1001 (e.g., a central processing unit, a graphics processor, etc.) that may perform various appropriate actions and processes in accordance with a program stored in a read-only memory (ROM 1002) or a program loaded into a random access memory (RAM 1004) from a storage device. In the RAM 1004, various programs and data required for the operation of the head-mounted display device are also stored. The processing devices 1001, ROM 1002, and RAM 1004 are connected to each other through a bus 1005. An input/output (I/O) interface is also connected to the bus 1005.

Generally, the following systems may be connected to the I/O interface 1006: an input device 1007 including, for example, a touch screen, a touch pad, a keyboard, a mouse, an image sensor, a microphone, an accelerometer, a gyroscope, etc.; an output device 1008 including, for example, a liquid crystal display (LCD), a loudspeaker, a vibrator, etc.; a storage device 1003 including, for example, a magnetic tape, a hard disk, etc.; and a communication device 1009. The communication device 1009 may allow the head-mounted display device to communicate wirelessly or wired with other devices to exchange data. Although a head-mounted display device having various systems is shown in the drawings, it should be understood that not all illustrated systems are required to be implemented or provided. More or fewer systems may alternatively be implemented or provided.

In particular, according to the embodiments of the present disclosure, the process described above with reference to the flowchart may be implemented as a computer software program. For example, an embodiment of the present disclosure includes a computer program product including a computer program stored on a computer readable medium, the computer program including program code for executing the method shown in the flowchart. In such an embodiment, the computer program may be downloaded and installed from the network through the communication device, or installed from the storage device 1003, or installed from the ROM 1002. When the computer program is executed by the processing device 1001, the above functions defined in the method of the embodiments of the present disclosure are performed.

According to the head-mounted display device provided in the present disclosure, by using the sound production control method in Embodiment 1 or Embodiment 2, the sound production effect of the VR device at low frequencies can be improved by using the bass sound production speaker, and the sound can be corporately produced by the speaker and the speaker unit inside the VR device, thereby realizing personalized selection of the sound. Compared with the prior art, the beneficial effects of the head-mounted display device provided by the embodiments of the present disclosure are the same as those of the sound production control method provided in Embodiment 1, and other technical features in the head-mounted display device are the same as those disclosed in the method of the previous embodiment, which will not be repeated here.

It should be understood that parts of the present disclosure may be implemented by hardware, software, firmware, or a combination thereof. In the above description of the embodiments, specific features, structures, materials or characteristics may be combined in a suitable manner in any one or more embodiments or examples.

The foregoing descriptions are merely specific embodiments of the present disclosure, but the protection scope of the present disclosure is not limited thereto, and any person having ordinary skills in the art may easily conceive of changes or replacements within the technical scope disclosed in the present disclosure, and all fall within the protection scope of the present disclosure. Therefore, the protection scope of the present disclosure shall be subject to the protection scope of the claims.

### Embodiment 4

An embodiment of the present disclosure provides a computer storage medium, wherein the computer storage medium is a computer storage medium which has computer-readable program instructions stored thereon, and the computer-readable program instructions are used to perform the sound production control method in Embodiment 1.

The computer storage medium provided in this embodiment of the present disclosure may be, for example, a USB flash drive, but is not limited to an electronic, magnetic, optical, electromagnetic, infrared, or semiconductor system, system or device, or any combination thereof. More specific examples of the computer storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In this embodiment, the computer storage medium may be any tangible medium that contains or stores a program, and the program may be used by or in combination with an instruction execution system, system or device. Program code embodied on the computer storage medium may be transmitted using any appropriate medium, including but not limited to wireline, optical fiber cable, RF (Radio Frequency), etc., or any suitable combination of the foregoing.

The computer storage medium may be included in the head-mounted display device, or may be applied alone without being assembled into the head-mounted display device.

One or more programs are stored on the computer storage medium, and when the one or more programs are executed by the head-mounted display device, the head-mounted display device: receives speaker frequency sweep signals of at least one speaker, and determines a bass sound production speaker according to each of the speaker frequency sweep signals; determines a correction curve corresponding to the speaker frequency sweep signals based on a pre-stored target frequency response, and gathers the correction curves corresponding to each of the speaker frequency sweep signals to obtain a correction curve set; and determines speaker position information corresponding to the speaker frequency sweep signal according to the collected instruction transceiving delay value, and performs sound production control according to the speaker position information, the correction curve set, and the bass sound production speaker.

Computer program code for carrying out operations for aspects of the present disclosure may be written in any combination of one or more programming languages, including object oriented programming languages such as Java, Smalltalk, C++ or the like, and conventional procedural programming languages such as “C” programming language or similar programming languages. The program code may be executed entirely on the user's computer, partly on the user's computer, as a stand-alone software package, partly on the user's computer and partly on a remote computer, or entirely on the remote computer or server. In cases involving a remote computer, the remote computer may be connected to the user's computer through any type of network, including a local area network (LAN) or a wide area network (WAN), or may be connected to an external computer (for example, through the Internet using an Internet Service Provider).

The flowcharts and block diagrams in the Figures illustrate the architecture, functionality, and operation of possible embodiments of systems, methods, and computer program products according to various embodiments of the present disclosure. In this regard, each block in the flowcharts or block diagrams may represent a module, segment, or portion of code, which includes one or more executable instructions for implementing the specified logical function(s). It should also be noted that, in some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or operations, or combinations of special purpose hardware and computer instructions.

The modules involved in the embodiments of the present disclosure may be implemented by software or hardware. The name of the module does not constitute a limitation on the unit itself under certain circumstances.

According to the computer storage medium provided in the present disclosure, computer-readable program instructions used to perform the foregoing sound production control method are stored, so that a sound production effect of a VR device at low frequencies can be improved by vocalization of a bass sound production speaker, and a sound can be produced together through an internal speaker unit of the VR device and a speaker, thereby implementing personalized selection of sound production. Compared with the prior art, beneficial effects of the computer storage medium provided in the embodiments of the present disclosure are the same as those of the sound production control method provided in Embodiment 1 or Embodiment 2, and details are not described herein again.

### Embodiment 5

An embodiment of the present disclosure further provides a computer program product, including a computer program, wherein when the computer program is executed by a processor, the steps of the foregoing sound production control method are implemented.

According to the computer program product provided in the present disclosure, a sound production effect of the VR device at low frequencies can be improved by using a bass sound production speaker, and a sound can be produced together through an internal speaker unit of the VR device and the speaker, to implement personalized selection of sound production. Compared with the prior art, beneficial effects of the computer program product provided in the embodiments of the present disclosure are the same as those of the sound production control method provided in Embodiment 1 or Embodiment 2, and details are not described herein again.

The above are only preferred embodiments of the present disclosure, and are not intended to limit the scope of the patent of the present disclosure, and all equivalent structures or equivalent flow transformations made by using the specification and the accompanying drawings of the present disclosure, or direct or indirect applications in other related technical fields, are all included in the scope of the patent processing of the present disclosure.

1. A sound production control method applied to a head-mounted display device, the sound production control method comprising:
receiving speaker frequency sweep signals of a plurality of speakers, and determining a bass sound production speaker according to each of the speaker frequency sweep signals;
determining correction curves corresponding to the speaker frequency sweep signals respectively based on a pre-stored target frequency response, and gathering the correction curves corresponding to the speaker frequency sweep signals to obtain a correction curve set; and
determining speaker position information corresponding to the speaker frequency sweep signals according to a collected instruction transceiving delay value, and performing a sound production control according to the speaker position information, the correction curve set and the bass sound production speaker.

2. The sound production control method according to claim 1, wherein the determining the bass sound production speaker according to each of the speaker frequency sweep signals comprises:
sequentially determining bass sound performance curves corresponding to the speaker frequency sweep signals respectively, and detecting whether each of the bass sound performance curves matches a pre-stored optimal bass sound performance curve, wherein Fourier transform is performed on the speaker frequency sweep signals to obtain performance curves, and the bass sound performance curves are curves with frequency values less than a preset frequency value among the performance curves; and
if a bass sound performance curve matches the pre-stored optimal bass sound performance curve, determining a speaker corresponding to a speaker frequency sweep signal matching the optimal bass sound performance curve as the bass sound production speaker.

3. The sound production control method according to claim 2, wherein the determining correction curves corresponding to the speaker frequency sweep signals respectively based on a pre-stored target frequency response comprises:
determining mid-high sound performance curves corresponding to the speaker frequency sweep signals respectively, and determining speaker frequency responses corresponding to the mid-high sound performance curves, wherein the mid-high sound performance curves are curves with frequency values greater than or equal to the preset frequency value among the performance curves;
determining differences between the speaker frequency responses and the pre-stored target frequency response as correction dashed lines; and
receiving speaker sound production signals corresponding to the correction dashed lines, and performing the sound production control according to the speaker sound production signals and the correction dashed lines to obtain correction curves.

4. The sound production control method according to claim 3, wherein the performing the sound production control according to the speaker sound production signals and the correction dashed lines to obtain the correction curves comprises:
determining the mid-high sound performance curves in the speaker sound production signals, and performing frequency response calibrations on the mid-high sound performance curves based on the correction dashed lines to obtain sound production frequency responses;
detecting whether differences between the sound production frequency responses and the target frequency response are less than a preset value; and
if the differences between the sound production frequency responses and the target frequency response are less than the preset value, determining that the correction dashed line are the correction curves.

5. The sound production control method according to claim 1, wherein the method comprises: before the determining the speaker position information corresponding to the speaker frequency sweep signals according to the collected instruction transceiving delay value, determining high frequency sound pressure information corresponding to the speaker frequency sweep signals, and determining a maximum sound pressure direction in the high frequency sound pressure information as a speaker angle position;
obtaining a first delay value which is a time delay value between a time at which an instruction is played and a time at which the instruction is received at an initial position;
obtaining a second delay value which is a time delay value between a time at which an instruction is played and a time at which the instruction is received at an end position; and
taking a difference between the first delay value and the second delay value as an instruction transceiving delay value, wherein the determining the speaker position information corresponding to the speaker frequency sweep signals according to the collected instruction transceiving delay value comprises:
determining a speaker distance corresponding to the collected instruction transceiving delay value, and taking the speaker distance corresponding to the speaker angle position as the speaker position information corresponding to the sound frequency sweep signals.

6. The sound production control method according to claim 1, wherein the performing the sound production control according to the speaker position information, the correction curve set and the bass sound production speaker comprises:
determining a sound production demand corresponding to an audio to be played, and detecting whether the sound production demand is a mid-high sound production demand;
if the sound production demand is a mid-high sound production demand, receiving a mid-high sound frequency response sent from the speakers, determining a target correction curve of the mid-high frequency response in the correction curve set, and performing a frequency response calibration on the mid-high sound frequency response based on the speaker position information and the target correction curve, to perform mid-high sound production; and
if the sound production demand is not the mid-high sound production demand, controlling the bass sound production speaker to produce bass sound.

7. The sound production control method according to claim 1, wherein the method comprises: before the receiving the speaker frequency sweep signals of the plurality of speakers, establishing Bluetooth connections with Bluetooth of the speakers; and
sequentially sending speaker frequency sweep signal demand instructions to the plurality of speakers based on the Bluetooth connections,
wherein the receiving the speaker frequency sweep signals of the plurality of speakers comprises:
receiving the speaker frequency sweep signals generated by the plurality of speakers based on the speaker frequency sweep signal demand instructions.

8. The sound production control method according to claim 1, wherein the method further comprises: after the receiving the speaker frequency sweep signals of the plurality of speakers,
determining a personalized sound production speaker according to each of the speaker frequency sweep signals;
determining a personalized correction curve corresponding to the personalized sound production speaker based on a pre-stored personalized target frequency response;
determining personalized speaker position information corresponding to the personalized sound production speaker according to a collected personalized instruction transceiving delay value, and performing the sound production control according to the personalized speaker position information and the personalized correction curve.

9. A head-mounted display device, comprising:
at least one processor; and
a memory communicatively connected to the at least one processor,
wherein the memory stores instructions executable by the at least one processor, when the instructions are executed by the at least one processor, the at least one processor implement steps of the sound production control method according to claim 1.

10. A computer storage medium on which a program for achieving a sound production control method is stored, wherein the program for achieving the sound production control method is executed by a processor to implement steps of the sound production control method according to claim 1.

11. The sound production control method according to claim 2, wherein the method further comprises: after the detecting whether each of the bass sound performance curves matches the pre-stored optimal bass sound performance curve,
determining a pre-stored device bass sound performance curve, and detecting whether each of the bass sound performance curves matches the device bass sound performance curve; and
if a bass sound performance curve matches the device bass sound performance curve, determining a speaker corresponding to a speaker frequency sweep signal matching the device bass sound performance curve as the bass sound production speaker.

12. The sound production control method according to claim 3, wherein the method further comprises: after the determining the differences between the speaker frequency responses and the pre-stored target frequency response as the correction dashed lines,
determining a target speaker corresponding to a correction dashed line, and generating a sound production demand instruction based on the correction dashed line; and
sending the sound production demand instruction to the target speaker.

13. The sound production control method according to claim 6, wherein the method further comprises: before performing the sound production control based on the speaker position information,
collecting angle information, and correcting the speaker position information based on the angle information; and
updating the speaker position information according to the corrected speaker position information.

14. The sound production control method according to claim 6, wherein the method further comprises: after the performing the frequency response calibration on the mid-high sound frequency response based on the speaker position information and the target correction curve to perform mid-high sound production,
collecting movement information in real time, and determining a mid-high sound control instruction based on the movement information and the speaker position information;
controlling at least one speaker to generate a specified mid-high sound frequency response based on the mid-high sound control instruction; and
performing a frequency response calibration on the specified mid-high sound frequency response based on the target correction curve, to perform a mid-high sound production.

15. The sound production control method according to claim 8, wherein the determining the personalized sound production speaker according to each of the speaker frequency sweep signals comprises:
sequentially determining mid-high sound performance curves in the speaker frequency sweep signals, and detecting whether each of the mid-high sound performance curves matches a pre-stored optimal personalized sound performance curve, wherein the mid-high sound performance curves are obtained by performing Fourier transform on the speaker frequency sweep signals; and
if a mid-high sound performance curve matches the pre-stored optimal personalized sound performance curve, determining a speaker corresponding to the speaker frequency sweep signal matching the optimal personalized sound performance curve as the personalized sound production speaker.

16. The sound production control method according to claim 8, wherein the performing the sound production control according to the personalized speaker position information and the personalized correction curve comprises:
if a personalized demand instruction is received, determining a target personalized sound production speaker corresponding to the personalized demand instruction; and
performing a personalized sound production based on the target personalized sound production speaker.
